(19) United States
(12) Patent Application Publication
(10) Pub. No.: US 2025/0070348 A1
(43) Pub. Date: Feb. 27, 2025

(54) BATTERY MODULE

(71) Applicant: FCA US LLC, Auburn Hills, MI (US)

(72) Inventor: Tae Hyun Kim, Troy, MI (US)

(21) Appl. No.: 18/453,392

(22) Filed: Aug. 22, 2023

(51) Int. Cl. H01M 50/209; H01M 10/04; H01M 50/242; H01M 50/271; H01M 50/289

(52) U.S. Cl. CPC H01M 50/209; H01M 10/0468; H01M 50/242; H01M 50/271; H01M 50/289; H01M 10/0565

(57) ABSTRACT

A solid-state battery module includes a housing, a pre-compressed solid-state battery cell stack disposed within the housing, and first and second opposed interior surfaces facing and compressing the pre-compressed solid-state battery cell stack therebetween. At least one of the first and second interior surfaces is curved and configured to increase compression in a low pressure central area of the pre-compressed solid-state battery cell stack to facilitate providing an even distribution of pressure across the pre-compressed solid-state battery cell stack.

### FIELD

The present application relates generally to battery modules and, more particularly, to a compression housing and method for solid-state battery modules for electric vehicles.

### BACKGROUND

Solid state battery technology is a promising technology that could potentially replace conventional liquid electrolyte type batteries by providing improved battery performance with high energy density and improved thermal characteristics. To achieve such high performance, it is critical to maintain high compression between the solid electrolyte and the electrodes to mitigate any potential delamination or void issues that can potentially result in issues at the interface due to high resistance and propagation of dendrites. However, the compression induced on the cells throughout the stack may be subject to a large variation depending on how the module structure and cells are constrained. Uneven compression or large compression discrepancy induced within the stack or within the cell itself can potentially lead to an undesirable drop in cell performance or premature failure. Accordingly, while conventional solid state battery modules work well for their intended purpose, there is a desire for improvement in the relevant art.

### SUMMARY

In accordance with one example aspect of the invention, a solid-state battery module is provided. In one example embodiment, the solid-state battery module includes a housing, a pre-compressed solid-state battery cell stack disposed within the housing, and first and second opposed interior surfaces facing and compressing the pre-compressed solid-state battery cell stack therebetween. At least one of the first and second interior surfaces is curved and configured to increase compression in a low pressure central area of the pre-compressed solid-state battery cell stack to facilitate providing an even distribution of pressure across the pre-compressed solid-state battery cell stack.

In addition to the foregoing, the described solid-state battery module may include one or more of the following features: wherein the solid-state battery cell stack comprises a plurality of battery cells separated by a plurality of compression pads; wherein the curved interior surface is convex; wherein the curved interior surface is ellipsoidal; wherein the curved interior surface has a horizontal maximum thickness at a center width of the curved interior surface that decreases to a minimum thickness at opposed ends of the curved interior surface; and wherein the curved interior surface has a vertical maximum thickness at the center height of the curved interior surface that decreases to a minimum thickness at opposed top and bottom edges of the curved interior surface.

In addition to the foregoing, the described solid-state battery module may include one or more of the following features: wherein the housing includes a first pair of opposed walls coupled between a second pair of opposed walls to form a generally rectangular housing configured to receive the solid-state battery cell stack; wherein the curved interior surface is part of the housing; a spacer plate disposed between the curved interior surface and the solid-state battery cell stack; a spacer plate disposed between the housing and the solid-state battery cell stack, wherein the spacer plate includes the curved interior surface; and wherein the spacer plate further includes a curved exterior surface opposite the curved interior surface, wherein the curved exterior surface is disposed against the housing.

In addition to the foregoing, the described solid-state battery module may include one or more of the following features: wherein the spacer plate further includes a planar exterior surface opposite the curved interior surface, wherein the planar exterior surface is disposed against the housing; wherein the spacer plate is a first spacer plate, and wherein a planar second spacer plate is disposed between the curved interior surface and the solid-state battery cell stack; and wherein each of the first and second interior surfaces is curved and configured to increase compression in a low pressure central area of the pre-compressed solid-state battery cell stack to facilitate providing an even distribution of pressure across the pre-compressed solid-state battery cell stack.

In addition to the foregoing, the described solid-state battery module may include one or more of the following features: a reinforcement cover coupled to the housing to facilitate enclosing and protecting the solid-state battery cell stack and providing additional structural rigidity to the housing; wherein the reinforcement cover includes a flange configured to be inserted into a slot formed in the housing when attaching the reinforcement cover to the housing; and wherein the reinforcement cover includes a top reinforcement cover coupled to a top side of the housing, and a bottom reinforcement cover coupled to a bottom side of the housing.

In addition to the foregoing, the described solid-state battery module may include one or more of the following features: a pair of spacer plates arranged on opposite sides of the solid-state battery cell stack, wherein the spacer plates have a chosen thickness to accommodate manufacturing variability in the solid-state battery cell stack and/or a thickness of the housing; wherein the solid-state battery cell stack is pre-compressed with a pressure between approximately 1.0 MPa and approximately 3.0 MPa, and wherein the housing provides the support to maintain a compression of the pre-compressed solid-state battery cell stack; and wherein the housing includes a plurality of cutouts configured to provide clearance to a plurality of assembly rods and/or assembly beams such that the housing can be inserted over the solid-state battery cell stack while being pre-compressed, wherein the plurality of assembly rods and/or assembly beams squeeze opposite sides of the solid-state battery cell stack to pre-compress the solid-state battery cell stack.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a perspective view of an example partially assembled solid-state battery module in accordance with the principles of the present application;

FIG. 2 is another perspective view of the partially assembled solid-state battery module shown in FIG. 1, in accordance with the principles of the present application;

FIG. 3 is yet another perspective view of the partially assembled solid-state battery module shown in FIG. 1, in accordance with the principles of the present application;

FIG. 4 is a perspective view of the assembled solid-state battery module, in accordance with the principles of the present application;

FIG. 5A is a schematic side view of an example assembly process of the solid-state battery module shown in FIG. 1, in accordance with the principles of the present application;

FIG. 5B is another schematic side view of the solid-state battery module shown in FIG. 5A, in accordance with the principles of the present application;

FIG. 6 illustrates an example method of manufacturing the solid-state battery module shown in FIG. 4, in accordance with the principles of the present application;

FIG. 7A is a top view of an example housing wall that may be utilized in the solid-state battery module shown in FIG. 1, in accordance with the principles of the present application;

FIG. 7B is a side view of the housing wall shown in FIG. 7A, in accordance with the principles of the present application;

FIG. 8A is a top view of an example housing wall and inner layer that may be utilized in the solid-state battery module shown in FIG. 1, in accordance with the principles of the present application;

FIG. 8B is a side view of the housing wall and inner layer shown in FIG. 8A, in accordance with the principles of the present application;

FIG. 9A is a top view of an example spacer plate and cell stack that may be utilized in the solid-state battery module shown in FIG. 1, in accordance with the principles of the present application;

FIG. 9B is a top view of the spacer plate and cell stack shown in FIG. 9A with an additional spacer plate therebetween, in accordance with the principles of the present application; and

FIG. 10 is a partial perspective view of an example cell stack illustrating a low pressure central area of a battery cell, in accordance with the principles of the present application.

### DETAILED DESCRIPTION

According to the principles of the present application, systems and methods are described for a solid-state battery module. In one example, the module includes a box frame structure housing a compressed stack of solid-state cells and compression pads. One or more spacer plates or pads are disposed at each end of the cell stack, and the entire stack is pre-compressed to a desired pre-compression via one or more assembly beams or rods at each end. Slots in compression faces of the box frame structure allow the box frame structure to be placed over the compressed cell stack with the assembly rods in place. The assembly rods are then slowly released for the stack to expand and compression fit inside the box frame structure to achieve the desired compression of the cell stack.

Accordingly, a single piece, solid structure box frame formed from a rigid material (e.g., aluminum casting, composite material, etc.) is provided with sufficient wall thickness and structural ridges to allow a compression fit of a cell stack inside to achieve the desired level of compression. A stack of cells can be pre-compressed and then press-fit into the box frame structure, or they can be pre-compressed and then the box frame structure with slots in the compression faces is lowered down and the stack released inside the box frame structure. The assembly mechanism and slots in the compression face can be multiple in numbers and spread across the compression face to minimize stress concentration. Additional spacer plates may be utilized at both ends of the stack to come into contact with the assembly rods during pre-compression of the stack. The thickness of the spacer plates can be chosen to control the final compression to account for various manufacturing tolerances of cells and the box frame structure.

The described battery module provides a structurally rigid solution for the high compression environments expected of the solid-state battery. No moving parts or assembly fasteners (e.g., bolts, studs, etc.) are required to apply the compression, thereby providing a simple and elegant structure and assembly process. Control over the final compression in the assembly can be achieved with a selection of spacer plates to achieve the desired compression. Mounting bosses can be integrated into the box frame structure design to fix the module down to a battery pack or vehicle frame. However, it will be appreciated that the battery module described herein may be utilized with various other system besides electric vehicles. The aspect ratio of the box frame structure can accommodate both long and short cell length. For a long cell length configuration, a reinforcement of the module with rigid top and bottom covers can be added for structural rigidity while promoting extra cell protection. Various aperture patterns on the covers minimize mass while providing sufficient strength at the top and bottom of the box frame structure.

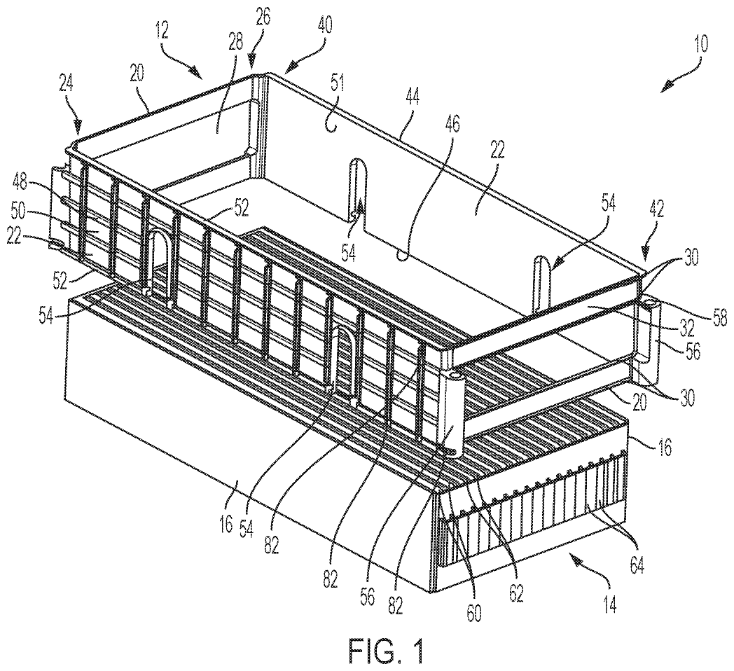

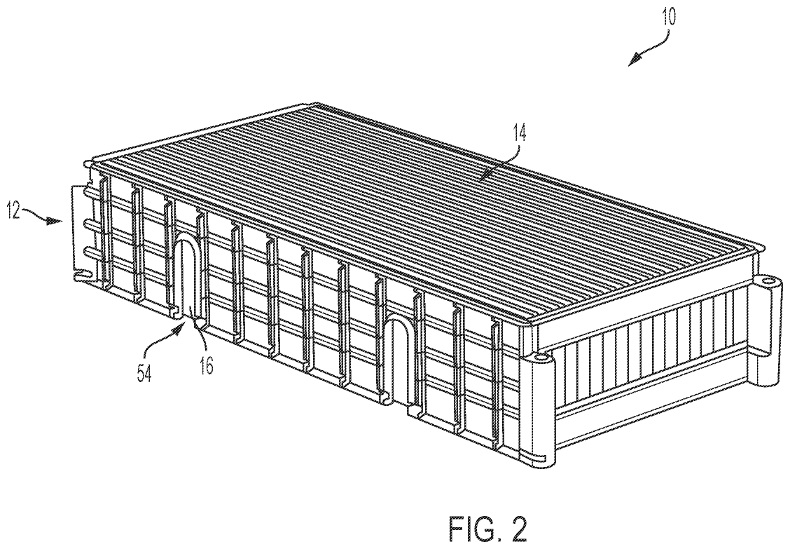

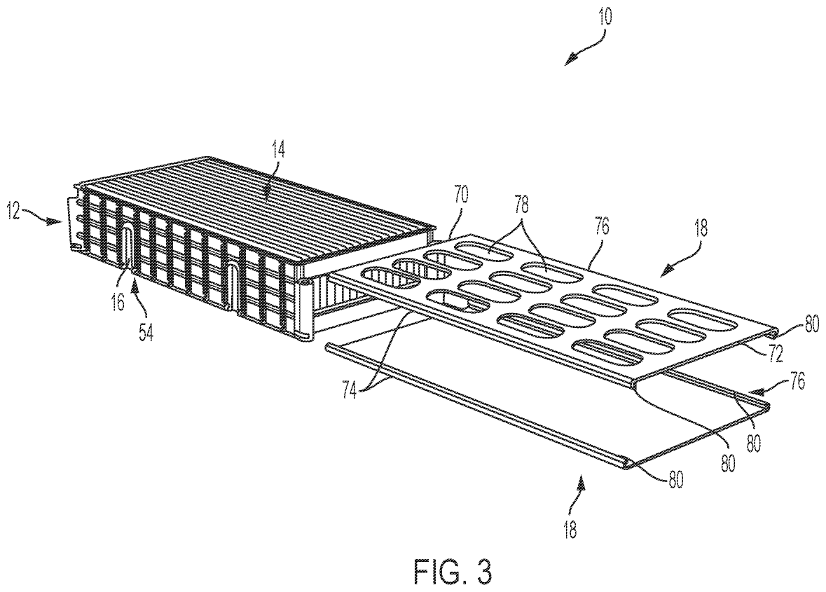

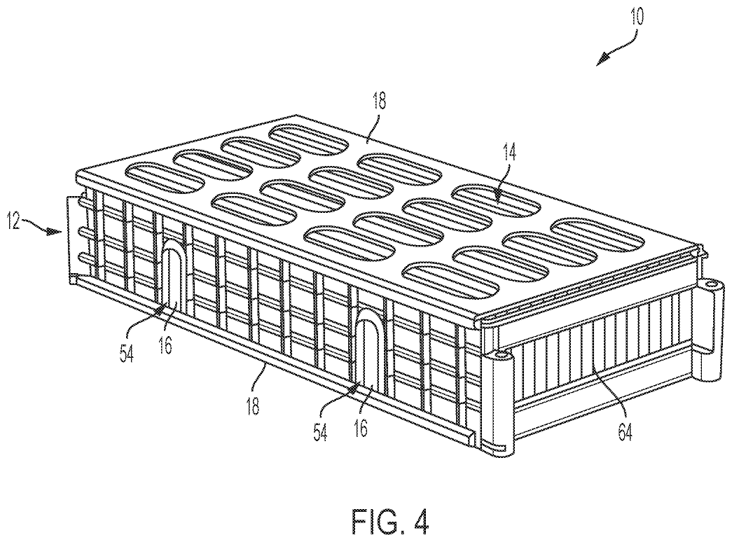

With initial reference to FIGS. 1-4, a solid-state battery module (SSBM) 10 is illustrated in accordance with the principles of the present disclosure. In the example embodiment, the SSBM 10 generally includes a box frame structure or housing 12, a solid-state battery cell stack 14, one or more spacer plates 16, and a pair of reinforcement covers 18. FIG. 1 illustrates the battery cell stack 14 and spacer plates 16 before insertion into the housing 12. FIG. 2 illustrates the battery cell stack 14 and spacer plates 16 after being pre-compressed and inserted into the housing 12. FIG. 3 illustrates covers 18 positioned for attachment to the housing 12 to enclose the battery cell stack 14 and spacer plates 16 therein. FIG. 4 illustrates the assembled SSBM 10.

With continued reference to FIG. 1, in the example embodiment, housing 12 generally includes a first pair of opposed walls 20 extending between a second pair of opposed walls 22 to form a generally rectangular box frame structure. In one example, housing 12 is a one-piece frame fabricated from a rigid material (e.g., aluminum, steel, high strength composite, etc.), for example, via cold stamping, injection molding, or other suitable manufacturing process. However, it will be appreciated that housing 12 may be formed from a plurality of separate components (e.g., walls) subsequently joined by a suitable connecting process (e.g., welding).

In the example embodiment, the walls 20, 22 have a sufficient predefined thickness to enable housing 12 to rigidly support a pre-compressed battery cell stack 14 at a predefined final compression force. In one example, the walls 20, 22 each have a thickness of between 1.0 mm and 3.0 mm, or between approximately 1.0 mm and approximately 3.0 mm. In another example, the walls 20, 22 each have a thickness of between 4.0 mm and 8.0 mm, or between approximately 4.0 mm and approximately 8.0 mm. However, it will be appreciated that walls 20, 22 may have any suitable thickness that enables SSBM 10 to function as described herein.

In the illustrated example, each wall 20 includes a first end 24 and an opposite second end 26. The first end 24 is coupled to an end of one wall 22, while the other end 26 is coupled to an end of the other wall 22. In some examples, like the one shown, one or more portions of the wall 20 are removed, for example to reduce weight while still providing a desired structural rigidity, thereby resulting in one or more windows or apertures 28. Edges of the remaining material may include a ridge or flange 30 to increase strength and rigidity of the wall 20. In one example, flanges 30 extend perpendicular to or substantially perpendicular to a planar surface 32 of the wall 20.

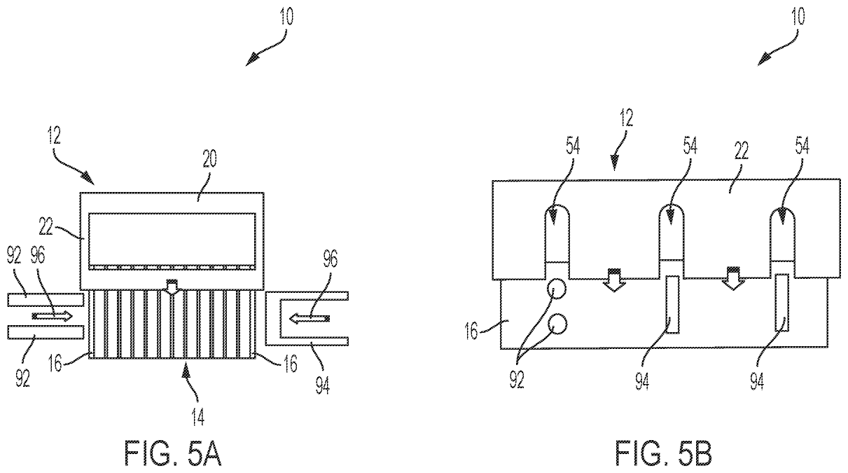

In the example embodiment, each wall 22 includes a first end 40, an opposite second end 42, a first or top edge 44, and an opposite second or bottom edge 46. The first end 40 is coupled to an end of one wall 20, while the other end 42 is coupled to an end of the other wall 20. Although not shown, one or more portions of the wall 22 may be removed, for example to reduce weight while still providing a desired structure rigidity. To increase structural rigidity, structural flanges or ribs 48 may be formed (e.g., stamped) into an outer surface 50 of each wall 22. In the illustrated example, the structural ribs 48 form a generally square or rectangular pattern in the outer surface 50. Additionally, the top and bottom edges 44, 46 may include a flange 52 to increase strength and rigidity of the wall 22. In one example, flanges 52 extend perpendicular to or substantially perpendicular to the outer surface 50 of the wall 22. Moreover, in the example embodiment, walls 22 include one or more slots or cutouts 54 formed therein to receive assembly machine components, as described herein in more detail in the discussion of FIGS. 5A-5B.

In the illustrated example, the housing 12 further includes integrated mounting bosses 56 located at each corner to provide increased structural rigidity and to enable the SSBM 10 to be coupled to another SSBM, a battery pack, a vehicle frame, or other vehicle component. As shown, each mounting boss 56 includes one or more apertures 58 extending at least partially through an axial extension of the mounting boss 56. In this way, aperture 58 is configured to receive a mounting/locating post (not shown) therein for attachment to the other component.

With continued reference to FIG. 1, the solid-state battery cell stack 14 generally includes a plurality of cells 60 separated by compression pads 62. Each cell 60 can have various configurations known to those skilled in the art. For example, although not shown in detail, each single solid-state type cell 60 can generally include a solid-state separator (e.g., ceramic or solid polymer electrolyte) disposed between a first electrode (e.g., cathode) and a second electrode (e.g., anode). In one example, cell 60 may be lithium-ion and include an anode of pure lithium metal. Each compression pad 62 is configured to absorb contact stresses and provide protection between adjacent cells, as well as absorb cell thickness variation as the cells 60 charge (thicken) or discharge (thin). It will be appreciated that stack 14 can include any number of cells 60 in various arrangements. Moreover, the battery cells 60 are electrically connected in series, parallel, or combinations thereof. The stack 14 includes a plurality of tabs or terminals 64 to electrically connect the cells 60 or other stacks 14 (not shown).

As shown in FIG. 1, spacer pads or plates 16 are disposed on opposite sides of the battery cell stack 14. In the example embodiment, the spacer plates 16 are configured to be contacted by assembly machine components when pre-compressing the battery cell stack 14, as described in more detail in FIGS. 5A and 5B. A thickness of each spacer plate 16 is chosen to provide a designed final compression (e.g., within a predefined tolerance) of battery cell stack 14 when disposed within the housing 12. For example, increasing spacer plate thickness will increase the final compression of the battery cell stack 14 and vice versa. Because the designed final compression of stack 14 is more sensitive than traditional liquid electrolyte batteries, adjusting the spacer plate thickness enables the final compression to be tightly controlled in light of manufacturing variability and size and design adjustments. In this way, varying thicknesses may be chosen to accommodate manufacturing variability in cells 60, the compression pads 62, and/or the thickness of housing 12.

With reference now to FIGS. 3 and 4, the SSBM 10 is provided with top and bottom reinforcement covers 18. In the example embodiment, once battery cell stack 14 and spacer plates 16 are pre-compressed and inserted into housing 12, the covers 18 are attached to the housing 12 to further enclose and protect the battery cell stack 14 and provide additional structural rigidity to the SSBM 10. In one example, each cover 18 is a one-piece frame fabricated from a rigid material (e.g., aluminum, steel, high strength composite, etc.), for example, via cold stamping, injection molding, or other suitable manufacturing process. However, it will be appreciated that cover 18 may be formed from a plurality of separate components (e.g., sections), which may be subsequently joined by a suitable connecting process (e.g., welding).

In the illustrated example, each cover 18 is a generally rectangular plate-like component having opposed first and second ends 70, 72 and opposed sides 74, 76. In some examples, like the one shown, one or more portions of the cover 18 are removed, for example to reduce weight while still providing a desired structural rigidity at the top and bottom of the housing 12, thereby resulting in one or more windows or apertures 78. Additionally, as shown in FIG. 3, each side 74, 76 includes a curved, inwardly extending flange 80 configured to be slidingly received within slots 82 formed in the housing 12. In the illustrated example, the slots 82 are formed in the outer surface 50 of walls 22, structural ribs 48, and mounting bosses 56. In this way, covers 18 can be attached to the housing 12 by inserting an end of flange 80 into the slots 82 and sliding the covers 18 across the top and bottom of housing 12 until positioned as shown in FIG. 4. However, it will be appreciated that covers 18 can be attached or coupled to the housing 12 in various other manners (e.g., dovetail, welding, etc.).

With reference now to FIGS. 5A and 5B, pre-compressing the battery cell stack 14 and spacer plates 16 for insertion into the housing 12 is illustrated. FIG. 5A illustrates an end view of the housing 12, battery cell stack 14, and spacer plates 16, and FIG. 5B illustrates a side view of the housing 12, battery cell stack 14, and spacer plates 16. In the example embodiment, the housing 12, battery cell stack 14, and spacer plates 16 are provided into an assembly machine 90 having one or more assembly rods 92 and/or assembly beams 94. The assembly rods/beams 92, 94 are then moved into contact with the spacer plates 16 (as shown by arrows 96) to squeeze and pre-compress the battery cell stack 14 to or slightly above the designed final compression. The assembly rods/beams 92, 94 are shaped to minimize local stress points, and as shown, multiple rods/beams may be deployed to spread the load on the spacer plate 16. With the assembly rods/beams 92, 94 continuing to provide the compressive force, the housing 12 is then inserted over the pre-compressed battery cell stack 14 and spacer plates 16.

As shown in FIG. 5B, the assembly rods/beams 92, 94 are located on the spacer plates 16 such that the cutouts 54 formed in the housing 12 provide clearance for the assembly rods/beams 92, 94. This enables the housing 12 to be lowered over the pre-compressed battery cell stack 14 and spacer plates 16 with the assembly rods/beams 92, 94 in place. Once the pre-compressed battery cell stack 14 and spacer plates 16 are inserted into the housing 12, the assembly rods/beams 92, 94 are withdrawn to allow the battery cell stack 14 to expand and compress fit within the housing 12 at the designed final compression of the stack 14.

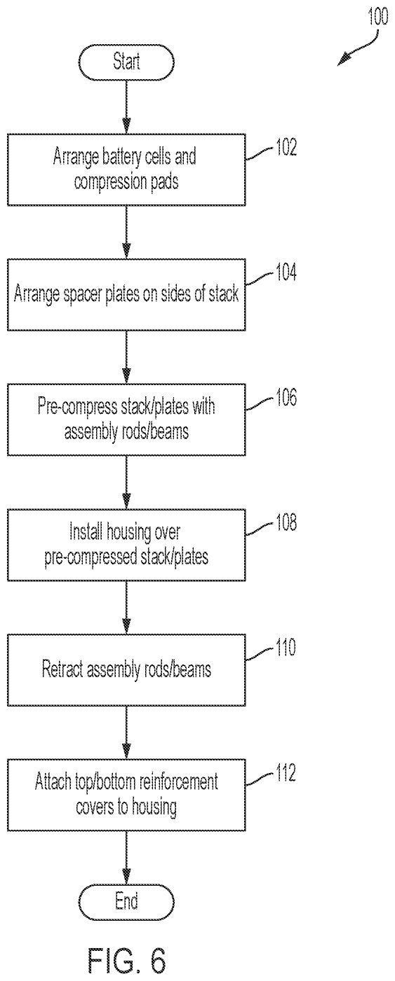

FIG. 6 illustrates an example method 100 of manufacturing the SSBM 10. The method 100 begins at step 102 where compression pads 62 are arranged between a plurality of cells 60 to form and provide solid-state battery cell stack 14. This step may be performed, for example, on an assembly table or assembly line. At step 104, one or more spacer plates 16 are provided and arranged on opposite sides of the battery cell stack 14. At step 106, the battery cell stack 14 and spacer plates 16 are pre-compressed utilizing assembly rods 92 and/or assembly beams 94. In one example, the stack 14 is pre-compressed to and/or has a final compression of between 1.0 MPa and 3.0 MPa or between approximately 1.0 MPa and approximately 3.0 MPa. However, it will be appreciated that the battery cell stack 14 may have any suitable pre-compression or final compression to provide adequate interfacing between the cell stack components.

At step 108, while pre-compressed, housing 12 is inserted (e.g., lowered) over the battery cell stack 14 and spacer plate(s) 16 with the housing cutouts 54 aligned with the assembly rods/beams 92, 94. At step 110, with the battery cell stack 14 and spacer plate(s) 16 completely within the housing 12, the assembly rods/beams 92, 94 are retracted to allow the stack 14 to expand and compress fit in the housing 12. At step 112, reinforcement covers 18 are attached to the top and bottom of the housing 12, for example by sliding the covers 18 from the side of the housing 12 into the slots 82 formed in the housing 12. This step may also be performed while the assembly rods/beams 92, 94 are compressing the stack 14.

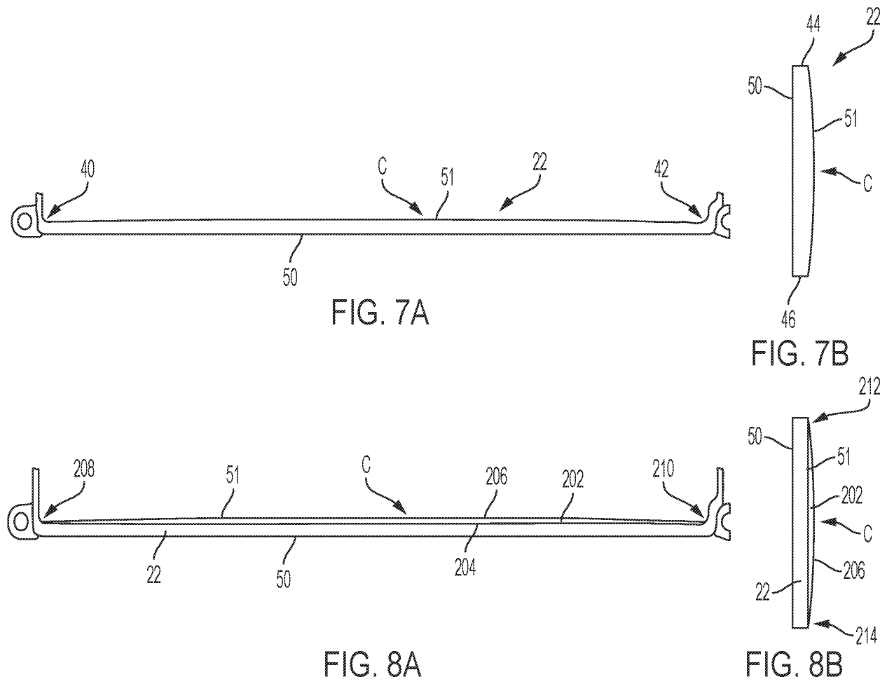

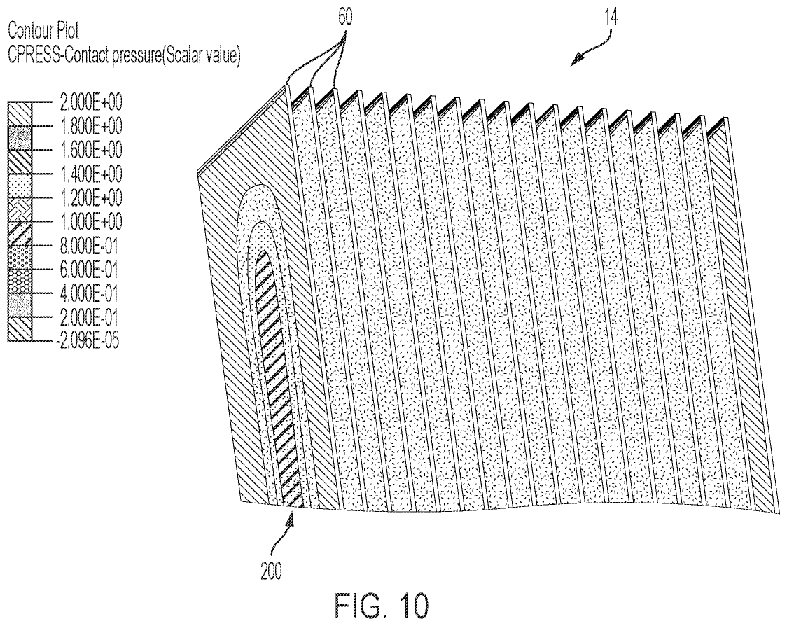

With reference now to FIGS. 7-10, some embodiments of the SSBM 10 include curved walls 22 or spacer plates 16 to provide homogenous compression to the battery cell stack 14. Due to the perimeter edges of the cell stack 14 (or cells 60) being rigidly secured to or constrained by the opposed end walls 20 and opposed covers 18, during operation, the edges will experience higher stresses, but smaller deflection. In contrast, larger deflection is expected in a middle or central, low pressure area 200 (FIG. 10) of cells 60 of the cell stack 14 compared to the cell stack edges. Accordingly, the inner wall/plate curvatures are configured to increase compression in the central area 200 to provide a desired cell stack pressure distribution. In this way, the use of a curved or convex inner wall in the module structure or spacer plate between the cell stack and the module wall passively promote evenly distributed contact pressure. In some embodiments, the curve may be semi-spherical, elliptical, ellipsoidal, or semi-ellipsoidal such that the curved surface profile is provided both horizontally and vertically to manage cell compression and cell expansion (e.g., breathing and swelling) required for solid-state battery technology or other battery cell type that requires compression. However, it will be appreciated that other shapes are contemplated.

FIGS. 7A and 7B illustrate top and side views of one example embodiment where housing 12 includes opposed walls 22 (only one shown) where outer surface 50 is straight or planar, and an interior surface 51 is curved or convex. The interior surface 51 is configured to face and contact the spacer plate 16 or cell stack 14 (if spacer plate 16 is not present). As shown in FIG. 7A, curved interior surface 51 has a horizontal maximum thickness at a center width ‘c’ of the wall 22 that decreases to a minimum value at each end 40, 42. Similarly, as shown in FIG. 7B, curved interior surface 51 has a vertical maximum thickness at a center height ‘c’ of the wall 22 that decreases to a minimum value at the top and bottom edges 44, 46. In this way, the curved interior surface 51 provides a generally convex, ellipsoidal surface to increase compression in the low pressure central area 200 of the cell stack 14 to facilitate providing an even distribution of pressure across the cell stack 14.

FIGS. 8A and 8B illustrate top and side views of one example embodiment where housing 12 includes opposed walls 22 (only one shown) where outer surface 50 and interior surface 51 are straight or planar. An additional generally rectangular inner layer 202 (e.g., a spacer plate) includes a planar exterior surface 204 and a curved or convex interior surface 206. The planar exterior surface 204 is configured to be disposed against the planar interior surface 51 of wall 22, and the curved interior surface 206 is configured to face and contact the spacer plate 16 or cell stack 14 (if spacer plate 16 is not present or inner layer 202 acts as spacer plate 16). As shown in FIG. 8A, curved interior surface 206 has a horizontal maximum thickness at a center width ‘c’ of the inner layer 202 that decreases to a minimum value at each end 208, 210. Similarly, as shown in FIG. 8B, curved interior surface 206 has a vertical maximum thickness at a center height ‘c’ of the inner layer 202 that decreases to a minimum value at the top and bottom edges 212, 214. In this way, the curved interior surface 206 provides a generally convex, ellipsoidal surface to increase compression in the low pressure central area 200 of the cell stack 14 to facilitate providing an even distribution of pressure across the cell stack 14.

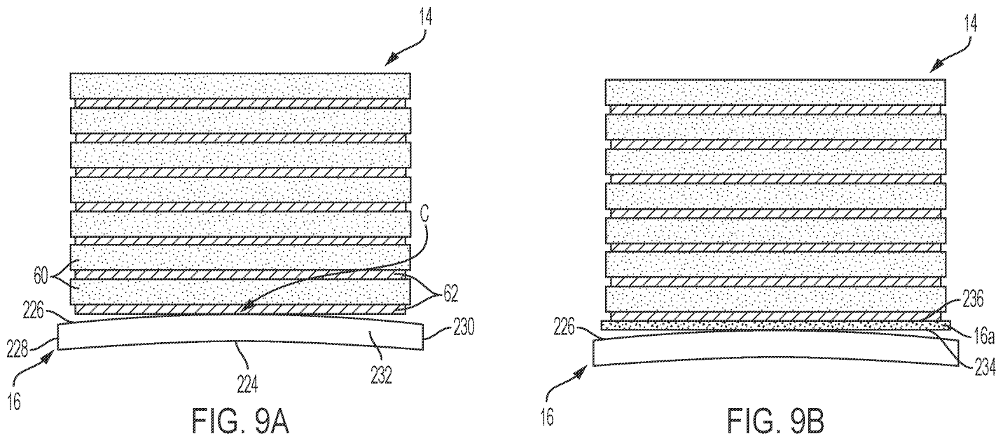

FIG. 9A illustrates a top view of one example embodiment where spacer plate 16 includes a curved or concave exterior surface 224 and a curved or convex interior surface 226. The curved exterior surface 224 is configured to face the housing wall 22, and the convex interior surface 226 is disposed against the cell stack 14. As shown in FIG. 9A, curved interior surface 226 has a horizontal maximum thickness at a center width ‘c’ of the spacer plate 16 that decreases to a minimum value at each end 228, 230. Similarly, although not shown, curved interior surface 226 has a vertical maximum thickness at a center height of the spacer plate 16 that decreases to a minimum value at the top edge 232 and bottom edge (not shown). In this way, the curved interior surface 226 provides a generally convex, ellipsoidal surface to increase compression in the low pressure central area 200 of the cell stack 14 to facilitate providing an even distribution of pressure across the cell stack 14.

FIG. 9B illustrates a top view of another example embodiment similar to that shown in FIG. 9A, except an additional spacer plate 16a is disposed between the curved interior surface 226 and the cell stack 14. The additional spacer plate 16a is a generally rectangular plate fabricated from a rigid material such as, for example steel. The additional spacer plate 16a includes a planar exterior surface 234 and an opposite planar interior surface 236. The planar exterior surface 234 is configured to be disposed against the curved interior surface 226, and the planar interior surface 236 is configured to be disposed against the cell stack 14. In this way, the curved interior surface 226 along with the additional spacer plate 16a are configured to increase compression in the low pressure central area 200 of the cell stack 14 to facilitate providing an even distribution of pressure across the cell stack 14.

Described herein are systems and methods for a solid-state battery module. Alternating battery cells and separator pads are arranged in a stack, pre-compressed, and disposed within a housing. Optional spacer plates are arranged on opposite sides of the cell stack. The housing and/or spacer plates include an interior curved surface that faces the cell stack to increase compression in a low pressure central area of the cell stack. In this way, the curved surface is configured to provide an even distribution of pressure across the cell stack as it expands and contracts during use. Top and bottom reinforcement covers are attached to the housing to enclose and protect the battery cell stack and provide additional structural rigidity to the housing. Accordingly, the battery module advantageously has very few parts and provides even pressure distribution across the cell stack to improve battery performance.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A solid-state battery module, comprising:
a housing;
a pre-compressed solid-state battery cell stack disposed within the housing; and
first and second opposed interior surfaces facing and compressing the pre-compressed solid-state battery cell stack therebetween,
wherein at least one of the first and second interior surfaces is curved and configured to increase compression in a low pressure central area of the pre-compressed solid-state battery cell stack to facilitate providing an even distribution of pressure across the pre-compressed solid-state battery cell stack.

2. The solid-state battery module of claim 1, wherein the solid-state battery cell stack comprises a plurality of battery cells separated by a plurality of compression pads.

3. The solid-state battery module of claim 1, wherein the curved interior surface is convex.

4. The solid-state battery module of claim 1, wherein the curved interior surface is ellipsoidal.

5. The solid-state battery module of claim 1, wherein the curved interior surface has a horizontal maximum thickness at a center width of the curved interior surface that decreases to a minimum thickness at opposed ends of the curved interior surface.

6. The solid-state battery module of claim 5, wherein the curved interior surface has a vertical maximum thickness at the center height of the curved interior surface that decreases to a minimum thickness at opposed top and bottom edges of the curved interior surface.

7. The solid-state battery module of claim 1, wherein the housing includes a first pair of opposed walls coupled between a second pair of opposed walls to form a generally rectangular housing configured to receive the solid-state battery cell stack.

8. The solid-state battery module of claim 1, wherein the curved interior surface is part of the housing.

9. The solid-state battery module of claim 8, further comprising a spacer plate disposed between the curved interior surface and the solid-state battery cell stack.

10. The solid-state battery module of claim 1, further comprising a spacer plate disposed between the housing and the solid-state battery cell stack, wherein the spacer plate includes the curved interior surface.

11. The solid-state battery module of claim 10, wherein the spacer plate further includes a curved exterior surface opposite the curved interior surface, wherein the curved exterior surface is disposed against the housing.

12. The solid-state battery module of claim 10, wherein the spacer plate further includes a planar exterior surface opposite the curved interior surface, wherein the planar exterior surface is disposed against the housing.

13. The solid-state battery module of claim 10, wherein the spacer plate is a first spacer plate, and wherein a planar second spacer plate is disposed between the curved interior surface and the solid-state battery cell stack.

14. The solid-state battery module of claim 1, wherein each of the first and second interior surfaces is curved and configured to increase compression in a low pressure central area of the pre-compressed solid-state battery cell stack to facilitate providing an even distribution of pressure across the pre-compressed solid-state battery cell stack.

15. The solid-state battery module of claim 1, further comprising a reinforcement cover coupled to the housing to facilitate enclosing and protecting the solid-state battery cell stack and providing additional structural rigidity to the housing.

16. The solid-state battery module of claim 15, wherein the reinforcement cover includes a flange configured to be inserted into a slot formed in the housing when attaching the reinforcement cover to the housing.

17. The solid-state battery module of claim 15, wherein the reinforcement cover comprises:
a top reinforcement cover coupled to a top side of the housing; and
a bottom reinforcement cover coupled to a bottom side of the housing.

18. The solid-state battery module of claim 1, further comprising a pair of spacer plates arranged on opposite sides of the solid-state battery cell stack,
wherein the spacer plates have a chosen thickness to accommodate manufacturing variability in the solid-state battery cell stack and/or a thickness of the housing.

19. The solid-state battery module of claim 1, wherein the solid-state battery cell stack is pre-compressed with a pressure between approximately 1.0 MPa and approximately 3.0 MPa, and
wherein the housing provides the support to maintain a compression of the pre-compressed solid-state battery cell stack.

20. The solid-state battery module of claim 1, wherein the housing includes a plurality of cutouts configured to provide clearance to a plurality of assembly rods and/or assembly beams such that the housing can be inserted over the solid-state battery cell stack while being pre-compressed,
wherein the plurality of assembly rods and/or assembly beams squeeze opposite sides of the solid-state battery cell stack to pre-compress the solid-state battery cell stack.
